(19) United States
(12) Patent Application Publication
(10) Pub. No.: US 2006/0231964 A1
(43) Pub. Date: Oct. 19, 2006

(54) Texture patching tube and nozzle

(75) Inventor: John R. Woods, Woodland Hills, CA (US)

Correspondence Address: PILLSBURY WINTHROP SHAW PITTMAN LLP, P.O BOX 10500, McLean, VA, 22102, US

(73) Assignee: Spraytex, Inc., Valencia, CA (US)

(21) Appl. No.: 11/106,291

(22) Filed: Apr. 14, 2005

(51) Int. Cl. B28C 5/00

(52) U.S. Cl. 264/36.2; 425/318

(57) ABSTRACT

A nozzle for use with a patching container and a caulking gun, and optionally, with a repair system, to patch over textured surfaces without interrupting the original texture pattern. The nozzle can be configured to create a variety of exterior surface textures used in patching or re-enforcing an area of repair.

### BACKGROUND OF THE INVENTION

1. Field of Invention

Embodiments of the present invention relate generally to a nozzle for use with a patching tube or container and a caulking gun, and optionally, with a texture repair kit. More particularly, embodiments of the present invention pertain to creating textures as well as patching or re-enforcing textured surfaces without materially disturbing the textured pattern.

2. Description of Related Art

Methods and products used to facilitate patching or caulking are generally known in the art and used to repair or patch a surface. Caulking is most typically used to provide a resilient seal between two adjacent structures, such as a window frame and a brick wall, to prevent water and air from entering the gap between the two adjacent structures. The caulk is usually stored within a tube or container having an end cap at one end and a dispensing nozzle at an opposing end. The caulk container is placed within a caulking gun assembly having a trigger actuator that displaces the end cap to force caulk through the dispensing nozzle. Traditionally, the nozzle is elongated and comes to a sharp point at the end. This form has been used commonly to allow the user to more easily focus and direct the caulking material.

In applying the patching or caulking material, a user traditionally places the dispensing nozzle immediately adjacent to the area to be sealed and slides the nozzle tip along the area as the trigger is being depressed. A common problem arises in that it is difficult to ensure that the area that is caulked maintains a straight and uniform area. The person applying the caulk often must smooth the caulk bead using a putty knife or other similar tool. Consequently, the task of ensuring the caulked or patched area matches the other surfaces is made even more difficult when the original surface has a unique texture. In such a case, conventional caulking or patching tools, such as the elongated nozzle tip, are often inadequate to use in dispensing the patching material in a manner that provides a surface texture consistent with the original surface. The person will need to manually recreate the specific texture or pattern using the putty knife or other similar tool.

Therefore, there exists a long-standing need to provide a patching tube or container with a nozzle which can create specific surface textures or patterns useful for caulking or patching an area in a manner to substantially maintain consistency with the original surface texture.

### BRIEF SUMMARY

In accordance with an embodiment of the invention, a patching container with a nozzle that can create specific textured patterns has been developed. The nozzle is convenient for use in association with the repair or patching of a textured surface. The nozzle can deliver an application of caulking or other patching material to repair an area of a textured surface without disrupting the original pattern of texture. The nozzle may also be compatible for use with any generic caulking or patching container.

An embodiment of the present invention relates to a patching tool comprising a cylindrical nozzle with a head portion that may be made from aluminum, plated steel or a similar durable yet flexible and bendable material. The nozzle is adapted to attach to a patching container with an open-end, from where the patching material exits. The head portion of the nozzle defines a series of openings from which the patching material will exit when pressure is applied to the container. The nozzle is secured to the patching container with a joining portion. The joining portion may be a skirt depending from the head portion. The skirt includes an attaching structure adapted to attach the nozzle to the patching container. The skirt may be selectively joined to and removed from the patching container. The attaching structure may be threads on the underside of the attaching structure that can be screwed onto complementary threads on the open-end of the patching container. Alternatively, the attaching structure may be a catch, detent, snap or a fastener that can attach the nozzle to the patching container.

The head portion defines a series of openings may be formed so that a specific texture can be recreated by patching a surface with the specific nozzle. For example, a type of textured surface often used on exterior surfaces is known in the industry as “Spanish lace.” This texture is traditionally created by applying an aggregate of surface materials in a number of dabs throughout the surface and then spreading the material with specific tools in a swirling motion. A user must manually create the texture on the applied surface with patching material in multiple stages. The resulting texture has a pattern that is reminiscent of lace. After this base material dries, a final coating of paint or other similar material is then applied over the textured surface. When an area of a surface textured with Spanish lace needs to be patched or repaired, the conventional caulking or patching tools will not be able to recreate the same texture to match the original surface. With an embodiment of the present invention, however, the nozzle will allow a user to repair an area and establish virtually the same Spanish lace texture so that there is little or no disruption of the original texture.

The patching assembly, including the nozzle attached to the patching container, may be placed in a caulking gun. A trigger on the caulking gun releases a plunger. The plunger generates a pressure in the plunger housing that is transferred through a plunger rod which facilitates the pushing of patching material out through the series of openings defined by the nozzle. Once a desired amount of patching material is urged through the defined openings of the nozzle, the user may press the top of the head portion flush against the area to be repaired. When removed, the patching material is left in particular configurations along the applied surface. A trowel or other manipulating tool can then be used to flatten out the area of applied patching material. Such a manipulating tool may also be attached as an accessory to the nozzle so that only one device is needed to create the texture. The configuration of caulking beads that are left by the nozzle are formed so that when a trowel or other manipulating tool is used to flatten out the beads, a Spanish lace texture results. The resulting texture does not require multiple materials or manipulation steps in order to match with the surrounding surface.

In other embodiments of the invention, the nozzle can be customized to recreate other specific patterns or textures. Each nozzle may define openings of varying positions or sizes, and each nozzle defines these openings in a predetermined configuration. In this way, each nozzle may yield specifically desired patterns depending on the user and the surface texture that the user wishes to create in an area or recreate on a repaired area.

In other embodiments, the nozzle may be configured in a variety of shapes other than cylindrical. Each shape allows the user to create a different pattern or texture with the applied viscous fluid or texture material. For example, the nozzle may be of a rectangular shape rather than cylindrical. In another embodiment, the nozzle may be in the shape of a three-pronged or “Y” configuration. The configuration is comprised of three prongs joined at a center point, with each prong extending separately out from that center point. This shape is known in the industry as “crow's feet.” In yet another embodiment, the nozzle may be of an oblong shape.

In the alternative, the patching container may come with a thin piece of foil sealed over the open-end. The user can then select the appropriate nozzle for the desired texture and attach that nozzle onto the patching container. By piercing openings in the foil according to those defined on the nozzle, the container is made ready for applying the patching material. As another option, the foil may be manufactured to be removable before the selected nozzle is attached. In this manner, the patching container may be manufactured to be used with any one of the nozzles, regardless of the specific texture design it will be used to recreate. The compatibility of these parts will increase the cost-effectiveness and convenience to users.

It is yet another object of the present invention to provide a nozzle that comes with accompanying accessories, such as a patching container, a manipulating tool and a caulking gun, all in a convenient system or kit. The system may allow a user to patch or repair and area so that it is substantially consistent with a surrounding surface with a textured pattern, such as Spanish lace. By providing, in one package, all the necessary tools to recreate the textured pattern on the repaired area, the system eliminates the burden of gathering the various tools separately and then attempting to manually apply and recreate the texture with conventional tools.

### BRIEF DESCRIPTION OF THE DRAWINGS

A detailed description of embodiments of the invention will be made with reference to the accompanying drawings, wherein like numerals designate corresponding parts in the figures.

FIG. 1a is a side-exterior view of a nozzle unattached and attached to a patching container according to an embodiment of the invention.

FIG. 1b is a side-exterior view of a nozzle, with a manipulating tool, attached to a patching container according to an embodiment of the invention.

FIG. 2 is a front-exterior view of a nozzle according to an embodiment of the invention.

FIG. 3 is a front-exterior view of a rectangular-shaped nozzle according to an embodiment of the invention.

FIG. 4a is a front-exterior view of a crow's feet-shaped nozzle, according to an embodiment of the invention.

FIG. 4b is a front-exterior view of an alternative crow's feet-shaped nozzle, according to an embodiment of the invention.

FIG. 5 is a cross-sectional view of a caulking gun with a patching assembly according to an embodiment of the invention.

FIG. 6 is a perspective view of a texture repair system including a caulking gun, a trowel, a patching container and a nozzle according to an embodiment of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departure from the scope of the present invention.

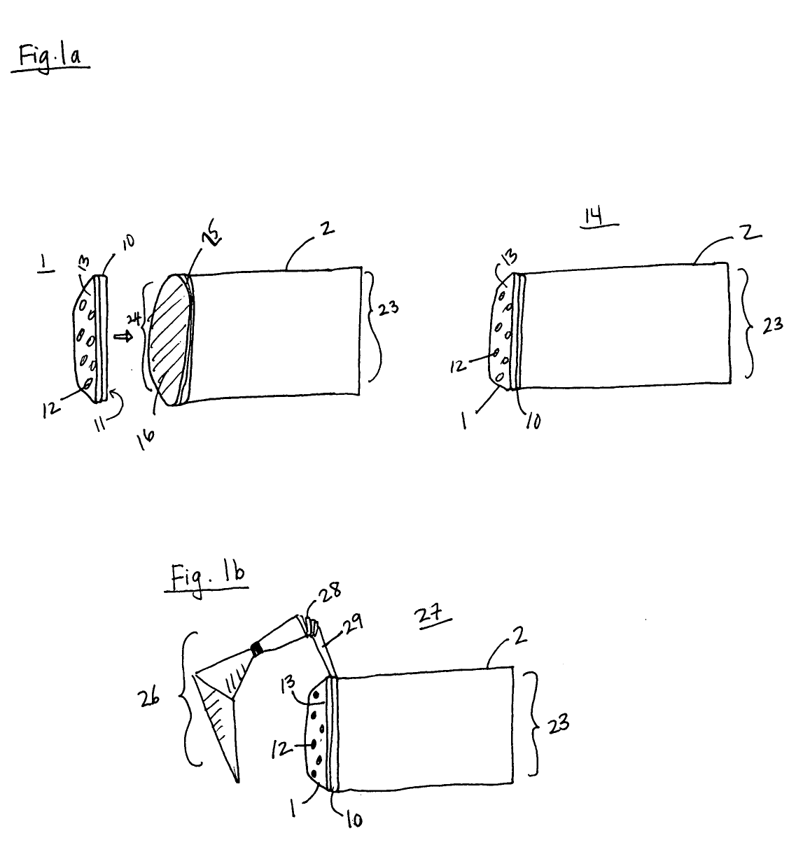

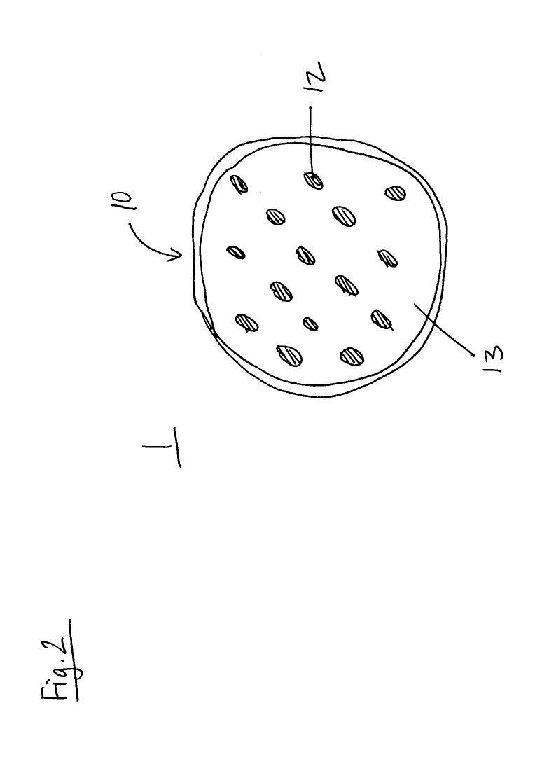

In FIG. 1a and FIG. 2, a generally cylindrical nozzle 1 for use in connection with a patching container 2 to repair areas of textured surfaces is illustrated. An embodiment of the present invention includes a cylindrical nozzle with a head portion made from aluminum, plated steel or a similar durable yet flexible and bendable material. The cylindrical nozzle 1 includes a generally cylindrical head portion 13, on which is defined a series of openings 12. When the nozzle 1 is attached to the patching container 2, the caulking or other patching material will exit through the defined openings 12 when pressure is applied to the patching container 2. The patching container 2 is illustrated with a closed-end 23 and an open-end 24. The caulking or other patching material is expelled from the patching container 2 through the open-end 24. In an embodiment of the invention, the patching container 2 may include a foil covering 16 sealed over the open-end 24. The head portion 13 allows the user to apply the expelled patching material over the repaired surface area by pressing the head portion 13 flush against the surface. After the patching material is applied, a manipulating tool (not shown), such as a trowel, sponge, or float, may be used to flatten the material. The head portion 13 defines a specific configuration of the openings 12 that help apply the expelled patching material in such a way that a user only needs to flatten the applied material to achieve a specific texture or pattern. In another embodiment, shown in FIG. 1b, a manipulating tool 26, such as a trowel, may be attached to the nozzle 1 by an arm 29. The extendable arm 29 includes a joint 28 that allows a user to adjust the angle and direction of the manipulating tool 26 as well as the length of how far the arm 29 extends. This alternative assembly 27 provides a convenient option where only one device is needed to create the texture.

The series of openings 12 shown in FIG. 1 a are defined so that a specific texture can be recreated by patching a surface with the specific nozzle 1. For example, the nozzle 1 shown may be used to recreate a surface with Spanish lace texture. When an area of a surface that has the Spanish lace texture needs to be patched or repaired, the conventional caulking tools will not be able to recreate the same texture to match the original surface. With an embodiment of the present invention, however, the nozzle 1 will allow a user to repair an area and establish substantially the same Spanish lace texture, or other desired texture, so that there is little or no disruption of the original texture.

As shown in FIG. 1a, the nozzle 1 further includes a joining portion or a skirt 10 that depends from the head portion 13. The skirt 10 is formed along the circumference of the head portion 13. The skirt 10 secures the nozzle 1 to the patching container 2 with an attaching structure. The skirt 10 may be selectively joined to and removed from the patching container 2. In one embodiment, the skirt 10 has an attaching structure that is one or more threads 11 on the underside of the head portion 13. There may be complementary threads 25 on the open-end 24 of the patching container 2. The threads 11 on the underside of the skirt 10 and the threads 25 on the open-end 24 of the patching container 2 are brought in contact and a screwing motion attaches the threads 11 on the head portion 13 and the threads 25 on the patching container 2 together to secure the two parts in an assembly. In alternative embodiments, the attaching structure may employ other means with which to attach the nozzle 1 to the patching container 2, such as catches, detents, snaps, fasteners or the like. Once the nozzle 1 and patching container 2 are attached, the patching assembly 14 may be used in connection with a caulking gun (not shown) to repair textured surfaces.

The nozzle 1 may accompany the patching container 2 or be offered separately. The patching container 2 may include a foil covering 16 over the open-end 24 as the embodiment shown in FIG. 1a. The user may attach the nozzle 1 to the patching container 2 and use a needle or other sharp object (not shown) to puncture holes in the foil covering 16. The user may use the defined series of openings 12 in the nozzle 1 to guide where to puncture the holes. In this manner, the user may keep and re-use a particular nozzle with multiple patching containers. Alternatively, the user may also purchase several nozzles for different desired textures and use each one with the same patching container 2, by simply removing the foil covering and attaching the selected nozzle to the patching container. In another embodiment, the nozzle may come removably attached to the patching container with no foil covering. The nozzle may also come fully integrated with the patching container as one piece.

Without being limited, several other embodiments of the nozzle comprising different shapes, and defining different configurations of openings, are described below. Because the structure of each embodiment focuses on the interaction between the nozzle and differing configurations, each embodiment is described with respect to the nozzle and its configuration. It is intended that the assembly not described have the same mating structure as the element that is described and is compatible with each of the embodiments.

The nozzle can be customized to recreate specific patterns or textures. In different embodiments, the nozzle may be configured in a variety of shapes to allow the user to create a different pattern or texture with the applied viscous fluid or texture material. For example, the nozzle may be of a rectangular shape, a cylindrical shape, a three-pronged shape, an oblong shape, or a triangular shape. Each nozzle may define openings of varying positions and varying sizes on the exterior applicator surface. Each nozzle defines these openings in a predetermined configuration. In this way, each nozzle may yield specifically desired patterns depending on the user and the surface texture that the user wishes to create on an area or recreate on a repaired area.

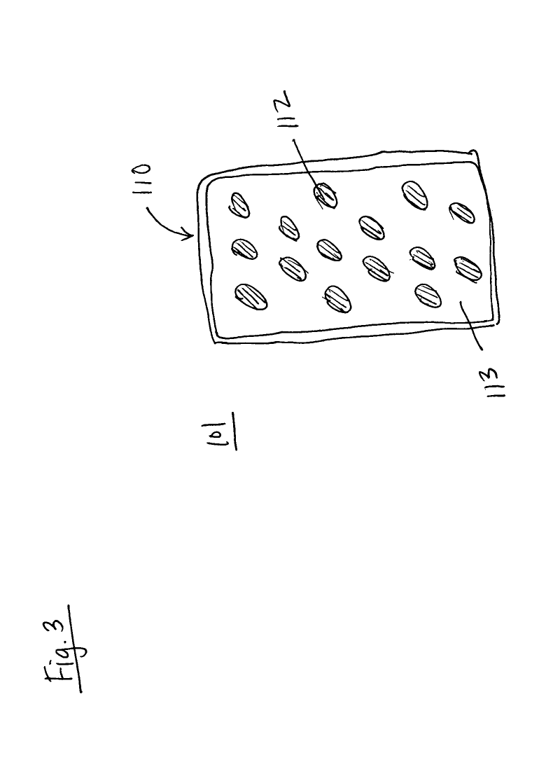

In one embodiment, shown in FIG. 3, the nozzle 101 may be of a rectangular shape rather than cylindrical. The head portion 113 defines a series of openings 112 are disposed throughout the head portion 113 to allow coverage of a rectangular area. The resulting texture is different from that which would result from the cylindrical embodiment. The nozzle 101 includes a joining portion or a skirt 110 which will secure the nozzle 101 to a compatible patching container with an attaching structure (not shown) that attaches the nozzle 101 onto the patching container together in an assembly. As described previously, the attaching structure of the skirt 110 may employ various means with which to attach the nozzle 101 to the patching container, such as threads, catches, detents, snaps, fasteners or the like.

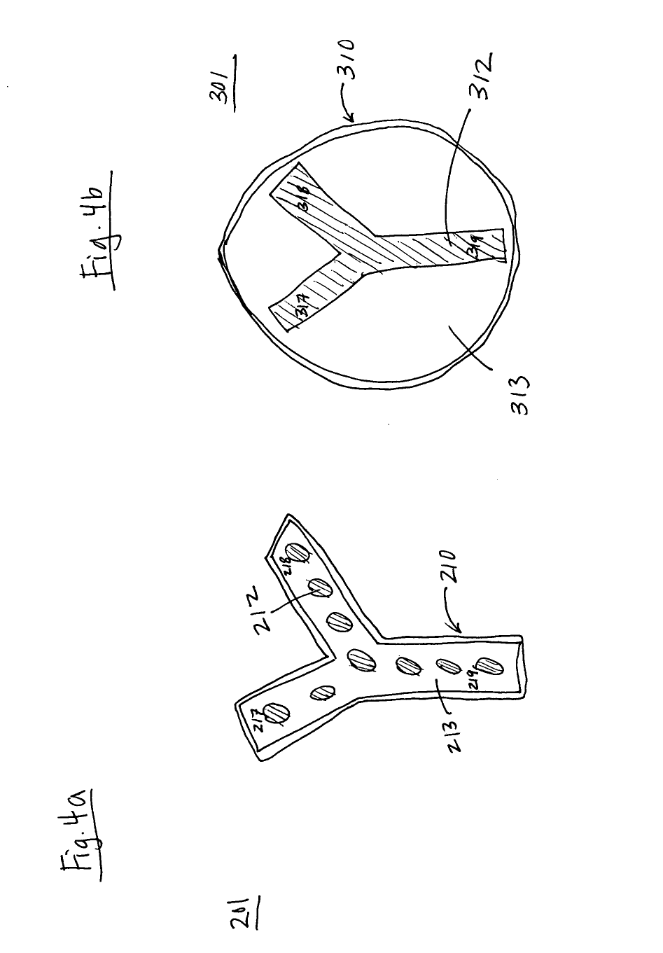

In another embodiment, shown in FIG. 4a, nozzle 201 may be in the shape of a three-pronged or “Y” configuration, otherwise known as crow's feet. The configuration shown in FIG. 4a is comprised of three prongs 217, 218, and 219 joined at a center point, with each prong extending separately out from that center point. The nozzle 201 includes a joining portion or a skirt 210 which secures the nozzle 201 to a compatible patching container with an attaching structure (not shown) that attaches the nozzle 201 onto the patching container together in an assembly. As described previously, the attaching structure of the skirt 210 may employ various means with which to attach the nozzle 201 to the patching container, such as threads, catches, detents, snaps, fasteners or the like.

In yet another embodiment, shown in FIG. 4b, the nozzle 301 is cylindrical in shape but defines an opening 312 that is in the shape of a three-pronged or “Y” configuration. The head portion defines an opening 312 that is configured with three prongs 317, 318, and 319 joined at a center point, with each prong extending separately out from that center point. This is an alternative variation on the crow's feet design described above. The defined opening 312 facilitates a unique application design, and the resulting texture is different from that which would result from the previous three embodiments. As with the other embodiments, the nozzle 301 includes a joining portion or a skirt 310 which secures the nozzle 301 to a compatible patching container with an attaching structure (not shown) that attaches the nozzle 301 onto the patching container together in an assembly. Likewise, the attaching structure of the skirt 310 may employ various means with which to attach the nozzle 301 to the patching container, such as threads, catches, detents, snaps, fasteners or the like.

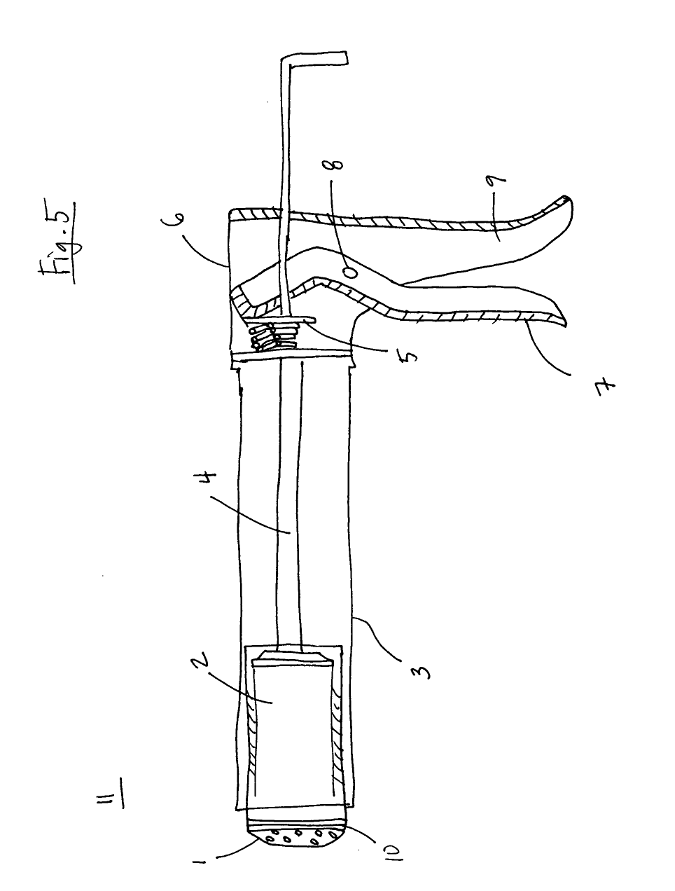

In FIG. 5, a field of use for the nozzle 2 and patching container 2 appears. The patching container 2 and nozzle 1 may be placed in a caulking gun 11. The patching container 2 is held in position within a container housing 3. The user applies the patching material by holding a trigger 7 and hand grip 9 together in one hand and contracting the two towards each other. The trigger 7 flexes on a pivot pin 8 on the caulking gun 11 and releases a plunger 5. The plunger 5 generates a pressure in the plunger housing 6 that is transferred through a plunger rod 4 which facilitates the pushing of the patching material out through the series of openings 12 defined in the nozzle 1.

Once a desired amount of patching material is urged through the defined openings 12 of the nozzle 1, the user may press the top of the head portion against the area to be repaired. When removed, the applied patching material (not shown) is left in particular configurations along the applied surface. The user may then utilize a manipulating tool (not shown), such as a trowel, sponge or float, to flatten out the area. The configuration of patching material that is left by the nozzle are formed so that when the manipulating tool is used to flatten out the beads, a Spanish lace texture may be created. The resulting texture does not require multiple materials or steps of manipulation in order to substantially match with the surrounding surface, and the user may simply paint over the patched area.

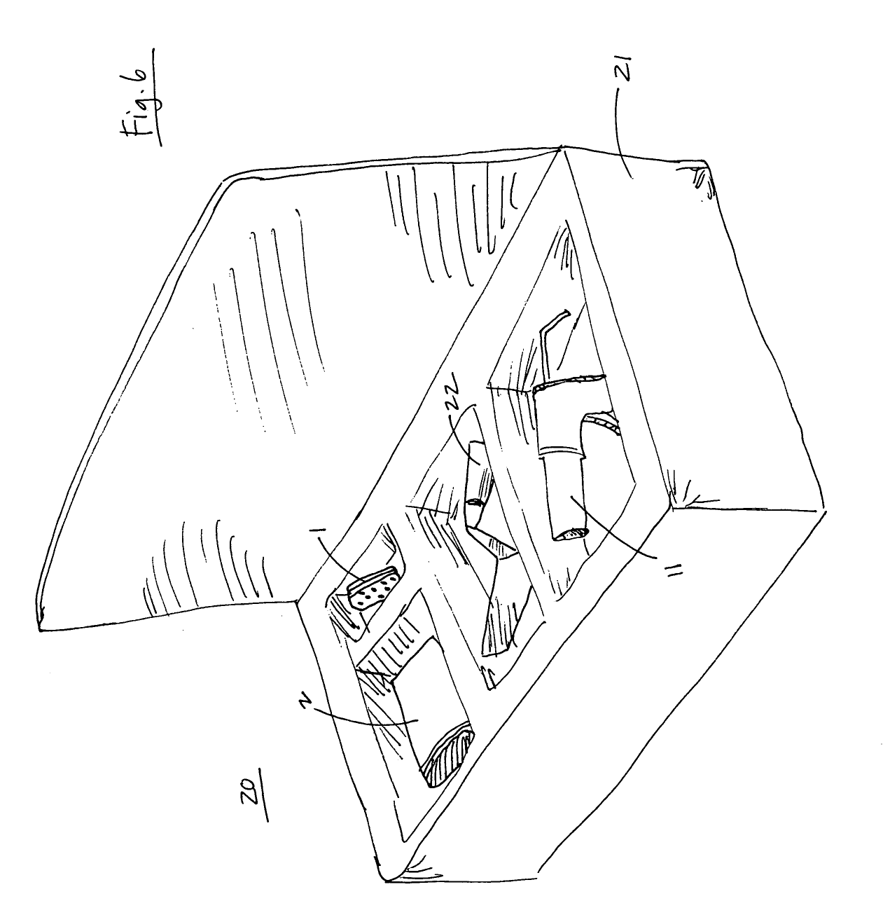

FIG. 6 illustrates another field of use for the nozzle 1 and patching container 2. A texture repair system 20 may include the nozzle 1 and accompanying accessories such as the patching container 2, a trowel 22, and caulking gun 11. In the alternative, the system may include several nozzles for creating different surface textures. The system may also provide other manipulating tools besides the trowel, such as a float or sponge. The system 20 provides a user with all the necessary tools with which to repair a textured surface while substantially maintaining the consistency of the texture. All the tools will be conveniently located in the same carrying case 21 so that the user may easily access each tool during the repair. The system 20 will allow the user to apply the patching material consistently with the surrounding surface so that the original textured pattern, such as Spanish lace, is virtually undisturbed. By providing, in one carrying case 21, all the necessary tools to recreate the textured pattern on an area, the system 20 eliminates the burden of gathering the various tools separately and then attempting to manually apply and recreate the texture with conventional tools.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A nozzle for use in applying a texture material to a surface, comprising:
a head portion including a defined series of selectively located openings disposed on the head portion, such that a texture material can be urged through the openings in a predetermined configuration, and
a skirt depending from the head portion, the skirt adapted to be selectively joined to and removed from a container of the texture material.

2. The nozzle of claim 1, wherein the head portion is formed in a shape selected from the group consisting of cylindrical, rectangular, oblong, square and triangular.

3. The nozzle of claim 1, wherein the head portion is formed in a shape known as crow's feet.

4. The nozzle of claim 1, wherein the defined openings are configured to produce a Spanish lace texture with the texture material.

5. The nozzle of claim 1, wherein a manipulating tool is attached to the nozzle to allow a user to flatten the texture material that is urged through the defined openings.

6. The nozzle of claim 1, wherein the skirt includes an attaching structure adapted to attach the nozzle onto the container of texture material, the attaching structure including a member selected from the group consisting of threads, catches, detents, snaps, and fasteners.

7. A patching assembly, comprising:
a nozzle including a head portion including a defined series of selectively located openings disposed on the head portion, such that a texture material can be urged through the openings in a predetermined configuration, and a skirt depending from the head portion, the skirt adapted to be selectively joined to and removed from a container of texture material,
a container of texture material, and
a pressure source adapted to urge the texture material in the container through the defined openings of the nozzle.

8. The patching assembly of claim 7, wherein the head portion is formed in a shape selected from the group consisting of cylindrical, rectangular, oblong, square and triangular.

9. The patching assembly of claim 7, wherein the head portion of the nozzle is in a shape known as crow's feet.

10. The patching assembly of claim 7, wherein the defined openings of the nozzle are configured to produce a Spanish lace texture.

11. The patching assembly of claim 7, wherein a manipulating tool is attached to the nozzle to allow a user to flatten the texture material that is urged through the defined openings.

12. The patching assembly of claim 7, wherein the skirt includes an attaching structure being adapted to attach the nozzle onto the container of texture material, the attaching structure including a member selected from the group consisting of threads, catches, detents, snaps, and fasteners.

13. The patching assembly of claim 7, wherein the pressure source is a caulking gun.

14. The patching assembly of claim 7, wherein the pressure source is a user.

15. A system for repairing textured surfaces, comprising:
a nozzle including a head portion defining a series of selectively located openings disposed on the head portion, such that a texture material can be urged through the defined openings in a predetermined configuration, and a skirt depending from the head portion, the skirt adapted to be selectively joined to and removed from a container of texture material,
a container of texture material,
a pressure source adapted to urge the texture material in the container through the defined openings of the nozzle, and
a manipulating tool.

16. The system of claim 15, wherein the manipulating tool is selected from the group consisting of a trowel, sponge, and float.

17. The system of claim 15 further including a second nozzle, wherein the second nozzle includes a defined series of openings disposed on the head portion, such that a texture material can be urged through the openings in a predetermined configuration different than that of the configuration of the first nozzle.

18. The system of claim 15, wherein the head portion is formed in a shape selected from the group consisting of cylindrical, rectangular, oblong, square and triangular.

19. The system of claim 15, wherein the head portion of the nozzle is in a shape known as crow's feet.

20. The system of claim 15, wherein the defined openings of the nozzle are configured to produce a Spanish lace texture.

21. The system of claim 15, wherein a manipulating tool is attached to the nozzle to allow a user to flatten the texture material that is urged through the defined openings.

22. The system of claim 15, wherein the skirt includes an attaching structure being adapted to attach the nozzle onto the container of texture material, the attaching structure including a member selected from the group consisting of threads, catches, detents, snaps, and fasteners.

23. The system of claim 15, wherein the pressure source is a caulking gun.

24. The system of claim 15, wherein the pressure source is a user.

25. A method for patching a textured surface so as to generally maintain an original texture, comprising:
providing a texture-forming tool including
a nozzle including a head portion defining a series of selectively located openings disposed on the head portion, such that a texture material can be urged through the defined openings in a predetermined configuration, and a skirt depending from the head portion, the skirt adapted to be selectively joined to and removed from a container of texture material,
a container of texture material, and
a caulking gun,
applying the texture material to form a predetermined texture, and manipulating the applied texture material so as to generally match the original texture.

26. The method of claim 25, wherein the applied texture material is manipulated by a manipulating tool attached to the nozzle.

27. The method of claim 25 further including the step of permitting the applied texture material to dry.

28. The method of claim 25 further including the step of applying a coating over the applied texture material.
